(19) United States
(12) Patent Application Publication
(10) Pub. No.: US 2023/0042216 A1
(43) Pub. Date: Feb. 9, 2023

(54) SYNTHETIC RESIN CONTAINER AND METHOD FOR MANUFACTURING SAME

(71) Applicant: TOYO SEIKAN CO., LTD., Shinagawa-ku, Tokyo (JP)

(72) Inventors: Yoichi TADOKORO, Yokohama-shi, Kanagawa (JP); Soya YOSHIDA, Yokohama-shi, Kanagawa (JP); Hiromitsu KIYOTO, Yokohama-shi, Kanagawa (JP)

(73) Assignee: TOYO SEIKAN CO., LTD., Shinagawa-ku, Tokyo (JP)

(21) Appl. No.: 17/790,566

(22) PCT Filed: Nov. 10, 2020
(86) PCT No.: PCT/JP2020/041816

§ 371 Date: Jul. 1, 2022

(30) Foreign Application Priority Data
Feb. 14, 2020 (JP) 2020-023187

(51) Int. Cl. B29C 33/42; B29C 49/22

(52) U.S. Cl. CPC B29C 33/42; B29C 49/22; B65D 23/00

(57) ABSTRACT

By providing a depressed portion 7 in a container main body 1a, forming a thick portion 5a in a covering layer 5 on an edge portion 7b of the depressed portion 7, and forming a thin portion 5b adjacent to the thick portion 5a in the covering layer 5 on a bottom surface 7a side of the depressed portion 7, when a synthetic resin container including a container main body molded into a predetermined container shape and a covering layer laminated on an outer peripheral surface side of the container main body is discarded, the container main body and the covering layer can be easily separated.

### TECHNICAL FIELD

The present invention relates to a synthetic resin container having a covering layer laminated on an outer peripheral surface side of a container main body and a method for manufacturing the synthetic resin container.

### BACKGROUND ART

Hitherto, synthetic resin containers have been manufactured by forming a preform having a bottomed cylindrical shape and made of thermoplastic resin such as polyethylene terephthalate, and then molding this preform into a bottle shape by biaxial stretch blow molding or the like. These synthetic resin containers are used in a wide range of fields as containers for various beverages, various seasonings, and the like.

These synthetic resin containers have become more familiar in recent years, and various proposals have been made accordingly. For example, in Patent Document 1, a composite container is proposed in which a container main body is recyclable as in the same manner as before, and a colored plastic member is peelably adhered to the entire area of the container main body other than a mouth portion in order to suppress deterioration of the contents due to light.

### CITATION LIST

### Patent Literature

Patent Document 1: JP 2016-055523 A

### SUMMARY OF INVENTION

### Technical Problem

Although it is stated in Patent Document 1 that the plastic member can be peeled off from the container main body by cutting the plastic member with a knife or the like, or can be peeled off along a cutting line provided on the plastic member, it is not easy in practice to peel off the plastic member adhered to the entire area of the container main body other than the mouth portion.

The present invention has been made in view of the above-described circumstances, and an object of this invention is to provide a synthetic resin container that includes a container main body molded into a predetermined container shape and a covering layer laminated on an outer peripheral surface side of the container main body, the synthetic resin container being able to be easily separated into the container main body and the covering layer at the time of disposal, and a method for manufacturing the synthetic resin container.

### Solution to Problem

A synthetic resin container according to the present invention includes a container main body molded into a predetermined container shape and a covering layer laminated on an outer peripheral surface side of the container main body, in which the container main body has a depressed portion lower than a surrounding area, and the covering layer has a thick portion in which a thickness of the covering layer is thicker than the surrounding area at a portion located on an edge portion of the depressed portion that rises from a bottom surface of the depressed portion, and a thin portion in which a thickness of the covering layer is thinner than the surrounding area at a portion adjacent to the thick portion and located on a bottom side of the depressed portion.

Further, a method for manufacturing a synthetic resin container according to the present invention is a method for manufacturing a synthetic resin container including a container main body molded into a predetermined container shape and a covering layer laminated on an outer peripheral surface side of the container main body, the method includes heating a preform including a preform main body having a bottomed cylindrical shape and a covering material layer laminated on an outer peripheral surface side of the preform main body to bring the covering material layer into a molten state or a semi-molten state while softening the preform main body to be stretchable, and subsequently blow molding the preform in a blow molding die in which a cavity surface is provided with a projecting portion at a steep angle with an edge portion being formed on a peripheral edge, the projecting portion being configured to shape a depressed portion in the container main body lower than a surrounding area, in which the covering material layer sandwiched between the preform main body stretched and the projecting portion is made to flow expanding into a peripheral edge side in which the edge portion of the projecting portion is formed, and the covering material layer is molded thicker on the peripheral edge side of the projecting portion in which the edge portion is formed, and the covering material layer sandwiched between the preform main body and an upper surface of the projecting portion is molded thinner.

### Advantageous Effects of Invention

According to the present invention, by breaking the thin portion formed on the bottom surface side of the depressed portion, and separating the thick portion formed on the edge portion of the depressed portion from the thin portion side, a starting point for tearing the covering layer can be formed, whereby the container main body and the covering layer can be easily separated.

### BRIEF DESCRIPTION OF DRAWINGS

FIG. 1 is a front view illustrating an outline of a synthetic resin container according to an embodiment of the present invention.

FIG. 2 is an end view taken along line A-A of FIG. 1.

FIG. 3 is an end view taken along line B-B of FIG. 1.

FIG. 4 is a vertical cross-sectional view illustrating an example of a preform.

FIG. 5 is an explanatory diagram illustrating an outline of an example of a blow molding die used in a method for manufacturing the synthetic resin container according to the embodiment of the present invention.

FIG. 6 is a perspective view of main portions of the blow molding die illustrated in FIG. 5.

FIG. 7 is an end view taken along line C-C of FIG. 6.

FIG. 8 is an explanatory diagram illustrating a process in which a band-shaped recessed portion is shaped by a strip-shaped protruding portion formed on a cavity surface of the blow molding die illustrated in FIG. 5.

FIG. 9 is an explanatory diagram illustrating a process in which the band-shaped recessed portion is shaped by the strip-shaped protruding portion formed on the cavity surface of the blow molding die illustrated in FIG. 5.

FIG. 10 is an end view taken along line D-D of FIG. 6.

FIG. 11 is an explanatory diagram illustrating a process in which a depressed portion is shaped by a projecting portion formed on the cavity surface of the blow molding die illustrated in FIG. 5.

FIG. 12 is an explanatory diagram illustrating a process in which the depressed portion is shaped by the projecting portion formed on the cavity surface of the blow molding die illustrated in FIG. 5.

FIG. 13 is an explanatory diagram illustrating a process in which the depressed portion is shaped by the projecting portion formed on the cavity surface of the blow molding die illustrated in FIG. 5.

FIG. 14 is a perspective view of main portions illustrating a modified example of a projecting portion formed on a cavity surface of a blow molding die.

FIG. 15 is an end view taken along line E-E of FIG. 14.

FIG. 16 is a perspective view of main portions illustrating another modified example of a projecting portion formed on a cavity surface of a blow molding die.

FIG. 17 is an end view taken along line F-F of FIG. 16.

### DESCRIPTION OF EMBODIMENTS

Preferred embodiment of the present invention will be described below with reference to the drawings.

### Synthetic Resin Container

First, a synthetic resin container according to an embodiment of the present invention will be described.

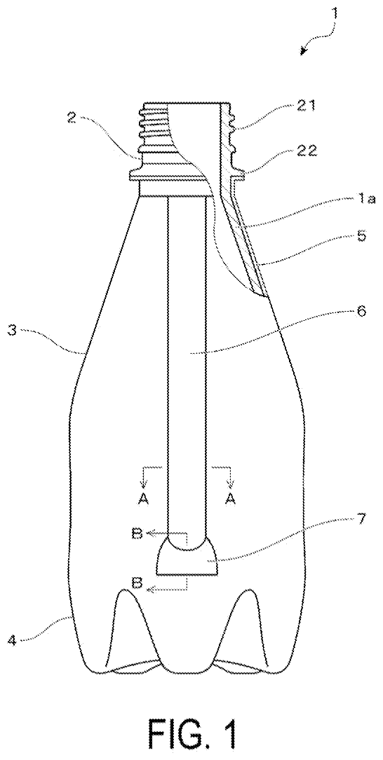

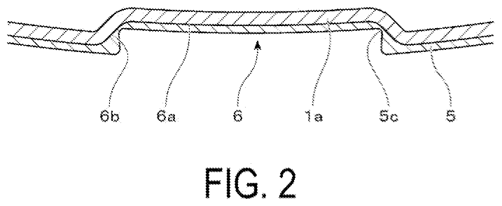

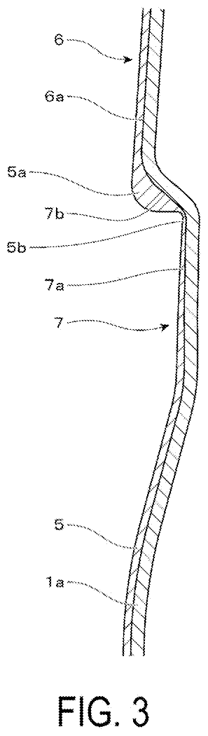

FIG. 1 is a front view illustrating an outline of the synthetic resin container according to the present embodiment. FIG. 2 is an end view taken along line A-A of FIG. 1. FIG. 3 is an end view taken along line B-B of FIG. 1.

A container 1 illustrated in these drawings includes a container main body 1a molded into a predetermined container shape having a mouth portion 2, a body portion 3, and a bottom portion 4, and a covering layer 5 laminated on an outer peripheral surface side of the container main body 1a. In the illustrated example, the container 1 (container main body 1a) is molded into a substantially cylindrical shape, and has a container shape by including the body portion 3 in which a portion on an upper side in a height direction is reduced in diameter toward the mouth portion 2, and the bottom portion 4 is formed into a so-called petaloid shape, but the shape of the container 1 is not limited thereto.

Here, FIG. 1 illustrates a cross section of a cut out portion from the mouth portion 2 to part of an upper end side of the body portion 3, but thicknesses of the container main body 1a and the covering layer 5 illustrated in the cross section are exaggerated. In other drawings, the thicknesses of the container main body 1a, the covering layer 5, and the like illustrated in the cross section are exaggerated as appropriate.

Further, the height direction refers to a direction orthogonal to a horizontal plane when the container 1 is upright on the horizontal plane with the mouth portion 2 up, and this state (as illustrated in FIG. 1) defines up-down, right-left, and longitudinal-lateral directions of the container 1.

The mouth portion 2 is a cylindrical portion that serves as a spout for the contents. On a side surface of an opening end side of the mouth portion 2, a thread 21 for attaching a lid body (not illustrated) is provided.

In addition, an annular neck ring 22 protruding outward along a circumferential direction is provided on a lower end side of the mouth portion 2.

As illustrated in the figure, the covering layer 5 is preferably laminated on the outer peripheral surface side of the container main body 1a so that the covering layer 5 covers the entire surface from a bottom surface of the bottom portion 4 to the peripheral surface of the body portion 3, and a distal end side of the covering layer 5 covers a lower surface of the neck ring 22 provided on the lower end side of the mouth portion 2 and reaches a peripheral end edge of the neck ring 22. Such an aspect is particularly suitable when the covering layer 5 is required to be colored to provide light-shielding properties in order to suppress deterioration of the contents due to light.

In addition, the container 1 can be manufactured by blow molding a preform 10, which includes a preform main body 10a, which has a bottomed cylindrical shape with one end open, in which a mouth portion 20 is formed on one end side of a cylindrical body portion 30 and a hemispherical bottom portion 40 is formed on another end side, and a covering material layer 50 laminated on an outer peripheral surface side of the preform main body 10a.

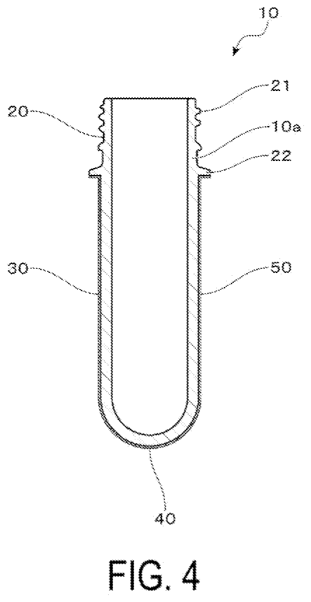

FIG. 4 illustrates an example of the preform 10. In order to manufacture the container 1 with the laminated covering layer 5 in the aspect described above, it is sufficient to use the preform 10 in which the covering material layer 50 is laminated on the outer peripheral surface side of the preform main body 10a so that the covering material layer 50 covers the entire surface from the bottom portion 40 to just below the mouth portion 20, and a distal end side of the covering material layer 50 covers a lower surface of the neck ring 22 provided on a lower end side of the mouth portion 20 and reaches a peripheral end edge of the neck ring 22.

The preform 10 is softened by heating to a state ready for blow molding, then set in a blow molding die and stretched axially (longitudinally) by a stretching rod as necessary from just below the neck ring 22 to the bottom portion 40, while being stretched axially and circumferentially (laterally) by high-pressure fluid blowing. A cavity shape of the blow molding die is then transferred to the stretched portion, molding the container 1 with a predetermined container shape. At this time, the container main body 1a is molded by the stretched preform main body 10a, and the covering material layer 50 laminated on the preform main body 10a is molded together with the preform main body 10a to form the covering layer 5 laminated on the container main body 1a.

When the preform 10 is blow molded in this way, the mouth portion 20 of the preform 10, including the neck ring 22, is not stretched in the blow molding process and becomes the mouth portion 2 of the container 1 as is. Thus, by using the preform 10 illustrated in FIG. 4, the distal end side of the covering material layer 50 covering the lower surface of the neck ring 22 also becomes the distal end side of the covering layer 5 of the container 1 as is, and thus the container 1 with the laminated covering layer 5 in the aspect described above can be manufactured.

In the present embodiment, the body portion 3 of the container main body 1a is provided with a band-shaped recessed portion 6 that is recessed toward the inside of the container and extends in a band shape with a predetermined width, and at both end edges of the band-shaped recessed portion 6 in the width direction, step portions 6b are formed that rise from a bottom surface 6a of the band-shaped recessed portion 6 and are connected to the peripheral surface of the body portion 3 (see FIG. 2).

As illustrated in FIG. 1, the band-shaped recessed portion 6 can be provided so as to extend from an upper end side (mouth portion 2 side) to a lower end side (bottom portion 4 side) of the body portion 3 along the height direction, and on one end side of the band-shaped recessed portion 6, a depressed portion 7 lower than a surrounding area is provided adjacent to the band-shaped recessed portion 6. The depressed portion 7 is provided so that a bottom surface 7a is recessed toward the inside of the container more than the peripheral surface of the adjacent body portion 3 and the bottom surface 6a of the band-shaped recessed portion 6, and is bordered by an edge portion 7b that rises from the bottom surface 7a of the depressed portion 7 and is connected to both the adjacent peripheral surface of the body portion 3 and the bottom surface 6a of the band-shaped recessed portion 6 (see FIG. 3).

Note that the bottom surface 7a of the depressed portion 7 can be a surface that is parallel or inclined along the axial direction, and may be a flat surface or a curved surface.

On the other hand, the covering layer 5 laminated on the outer peripheral surface side of the container main body 1a has a thick portion 5a in which a thickness of the covering layer 5 is thicker than the surrounding area at a portion located on the edge portion 7b that rises from the bottom surface 7a of the depressed portion 7 and is connected to the bottom surface 6a of the band-shaped recessed portion 6. In addition, a thin portion 5b in which a thickness of the covering layer 5 is thinner than the surrounding area is formed in a portion adjacent to the thick portion 5a and located on the bottom surface 7a side of the depressed portion 7 (see FIG. 3).

In this way, when discarding the container 1 after the contents have been consumed, the container main body 1a and the covering layer 5 can be easily separated by, for example, hooking a fingernail on the thick portion 5a formed on the edge portion 7b of the depressed portion 7 from the bottom surface 7a side of the depressed portion 7, breaking the thin portion 5b, separating the thick portion 5a from the thin portion 5b side, picking up the separated thick portion 5a with fingers, and tearing the covering layer 5 therefrom.

As described above, in the present embodiment, a starting point for tearing the covering layer 5 is formed by breaking the thin portion 5b formed on the bottom surface 7a side of the depressed portion 7 and separating the thick portion 5a formed on the edge portion 7b of the depressed portion 7 from the thin portion 5b side. However, in order to make it possible to more easily separate the container main body 1a and the covering layer 5, it is preferred to form a tear guide portion starting from the thick portion 5a in the covering layer 5.

As such a tear guide portion, linear thin portions 5c can be formed in the covering layer 5, which are linearly thinner than the surrounding area along the step portion 6b formed on both end sides of the band-shaped recessed portion 6 (see FIG. 2). This makes it possible to tear the covering layer 5 along the linear thin portions 5c formed as the tear guide portion while picking up the thick portion 5a separated from the thin portion 5b side.

### Method for Manufacturing Synthetic Resin Container

Next, a method for manufacturing the synthetic resin container according to the embodiment of the present invention will be described.

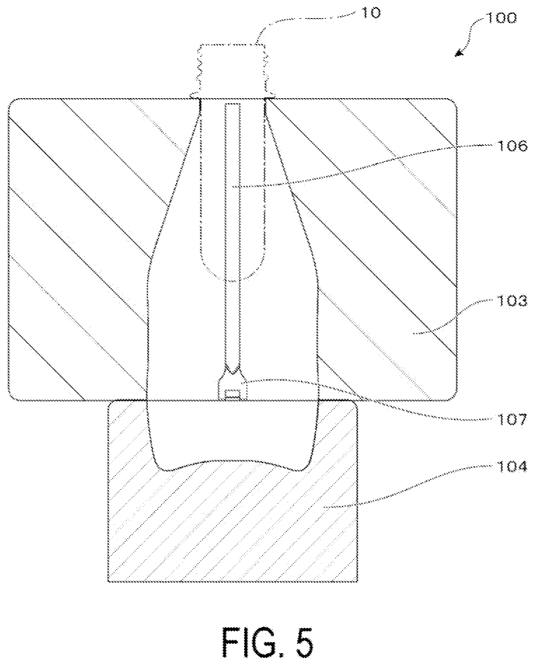

FIG. 5 is an explanatory diagram illustrating an outline of an example of a blow molding die used in the present embodiment.

A blow molding die 100 is used to mold the container 1 illustrated in FIG. 1, and includes a body die 103 for molding the body portion 3 of the container 1 and a bottom die 104 for molding the bottom portion 4 of the container 1. The body die 103 is composed of a pair of split dies that can be opened and closed. FIG. 5 illustrates a simplified cross section of the blow molding die 100 cut in a plane including a parting surface of the body die 103.

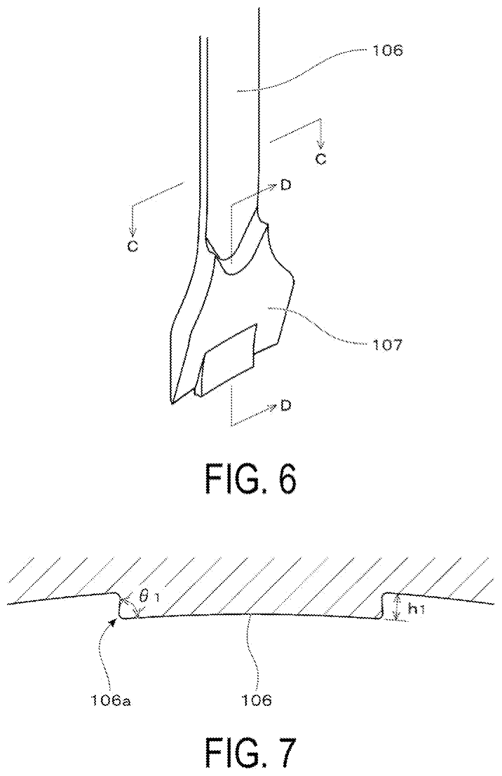

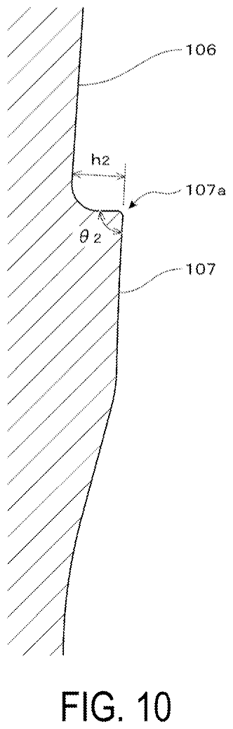

In the present embodiment, a cavity surface of the body die 103 is provided with a strip-shaped protruding portion 106 that shapes the band-shaped recessed portion 6 in the container main body 1a of the container 1 at a steep angle so that edge portions 106a are formed along both end edges in a width direction thereof (see FIGS. 6 and 7). The strip-shaped protruding portion 106 protrudes with a predetermined width and extends from an upper end side to a lower end side of the body die 103. On the lower end side of the body die 103, a projecting portion 107, which shapes the depressed portion 7 in the container main body 1a of the container 1, is provided adjacent to one end side of the strip-shaped protruding portion 106. The projecting portion 107 projects higher than the surrounding area, that is, projects higher than the adjacent cavity surface and the upper surface of the strip-shaped protruding portion 106, and is provided at a steep angle so that the edge portion 107a is formed on a peripheral edge (see FIGS. 6 and 10).

Here, FIG. 6 is a perspective view illustrating main portions including part of the strip-shaped protruding portion 106 and the projecting portion 107 in the cavity surface of the body die 103. FIG. 7 is an end view taken along line C-C of FIG. 6. FIG. 10 is an end view taken along line D-D of FIG. 6.

In order to manufacture the container 1 using such a blow molding die 100, first, as described above, the preform 10 is readied for the blow molding by heating, and then set in the blow molding die 100. At that time, the preform main body 10a is softened to have stretchability by heating the preform main body 10a to a temperature equal to or lower than the melting point and higher than the glass transition point of a resin material forming the preform main body 10a. On the other hand, the covering material layer 50 is heated to a temperature near the melting point of the resin material forming the covering material layer 50 (e.g., [melting point−30]° C. to [melting point+30]° C.), so that the covering material layer 50 is kept in a molten state or a semi-molten state with high fluidity.

Note that, in FIG. 5, the preform 10 set in the blow molding die 100 is illustrated by a dash-dotted line.

In order to heat both the preform main body 10a and the covering material layer 50 as described above when heating the preform 10, for example, the preform 10 is heated from the outside using an infrared heater or the like, and the preform 10 is also heated from the inside by, for example, inserting a rod-shaped high-frequency induction heating element into the preform 10 to adjust the heating temperature from the inside and outside as appropriate.

When the blow molding of the preform 10 is started in the blow molding die 100, the stretched portion comes into contact with the cavity surface, and the preform main body 10a (the body portion 3 of the container main body 1a) is shaped with the band-shaped recessed portion 6 by the strip-shaped protruding portion 106 and the depressed portion 7 by the projecting portion 107.

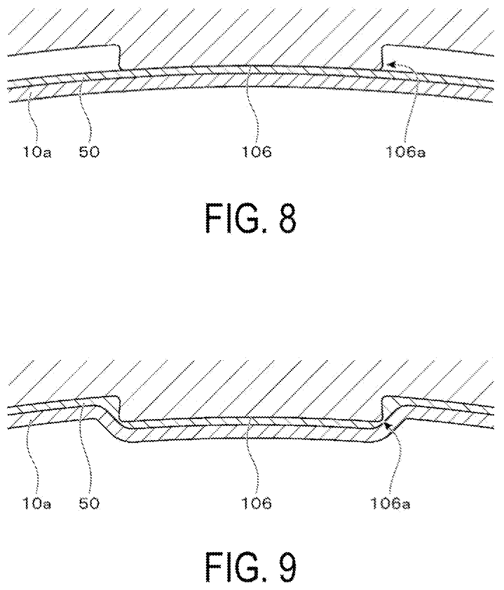

At this time, the band-shaped recessed portion 6 that is shaped in the preform main body 10a is not shaped as the shape of the strip-shaped protruding portion 106 provided at a steep angle so that the edge portions 106a are formed along both end edges. As illustrated in FIGS. 8 and 9, the preform main body 10a is stretched so that both end sides of a portion in contact with the upper surface of the strip-shaped protruding portion 106 with the covering material layer 50 interposed therebetween are curved against steps on both end edge sides of the strip-shaped protruding portion 106. The band-shaped recessed portion 6 is thus shaped so that the step portions 6b rising from the bottom surface 6a of the band-shaped recessed portion 6 and connected to the peripheral surface of the body portion 3 are formed at both end edges of the band-shaped recessed portion 6 (see FIG. 2).

In contrast, the covering material layer 50 is in a molten state or semi-molten state with high fluidity. Thus, as the preform main body 10a is stretched so as to be curved against the steps on both end edge sides of the strip-shaped protruding portion 106, when the covering material layer 50 is pressed against the edge portions 106a formed along both end edge sides of the strip-shaped protruding portion 106, portions of the covering material layer 50 that are pressed against the edge portions 106a flow, as pushed away, to fill spaces between the portions of the preform main body 10a that are stretched so as to be curved, and the steps on both end edge sides of the strip-shaped protruding portion 106. In this way, the covering material layer 50 is shaped so as to have substantially the shape of the strip-shaped protruding portion 106, and is molded so as to be linearly thinned along the edge portions 106a of the strip-shaped protruding portion 106 (see FIG. 9).

As a result, in the container 1 after blow molding, the linear thin portions 5c are formed in the covering layer 5 along the step portions 6b formed at both end edges of the band-shaped recessed portion 6, which are linearly thinner than the surrounding area (see FIG. 2).

When the linear thin portions 5c are formed in the covering layer 5 in this way, the narrower and clearer the linear thin portions 5c are formed, the easier it is to tear the covering layer 5 along the linear thin portions 5c. From this perspective, it is preferable to appropriately design the shape, dimensions, and the like of the strip-shaped protruding portion 106.

For example, a step h₁ of the strip-shaped protruding portion 106, that is, a height difference h₁ between the upper surface of the strip-shaped protruding portion 106 and the adjacent cavity surface in the illustrated example, and an angle θ₁ of edge portions 106a formed along both end edges of the strip-shaped protruding portion 106, that is, an angle θ₁ formed between the upper surface of the strip-shaped protruding portion 106 and a side surface of the strip-shaped protruding portion 106 that forms the edge portion 106a together with this upper surface, are appropriately designed from the above perspective.

Note that, as long as the linear thin portions 5c can be formed in the covering layer 5 as described above, the edge portions 106a formed along both end edges of the strip-shaped protruding portion 106 may be rounded as illustrated in FIG. 7.

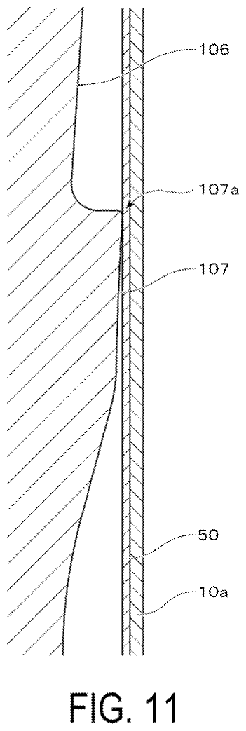

Similarly, the depressed portion 7 that is shaped in the preform main body 10a is not shaped as the shape of the projecting portion 107 provided at a steep angle so that the edge portion 107a is formed on the peripheral edge. As illustrated in FIGS. 11 to 13, when the stretched preform main body 10a comes into contact with the upper surface of the projecting portion 107 with the covering material layer 50 interposed therebetween, a portion on the peripheral edge side in which the edge portion 107a is formed is stretched so as to be curved against a step on the peripheral edge side. This causes the depressed portion 7 to be shaped so as to be bordered by the edge portion 7b that rises from the bottom surface 7a and is connected to both the adjacent peripheral surface of the body portion 3 and the bottom surface 6a of the band-shaped recessed portion 6 (see FIG. 3).

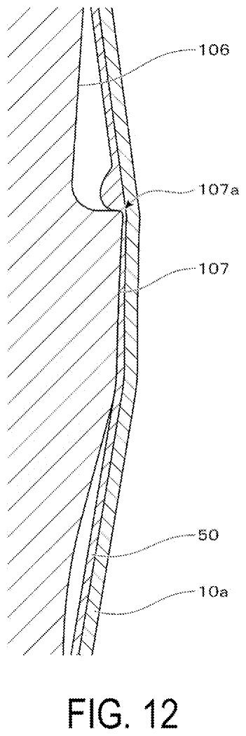

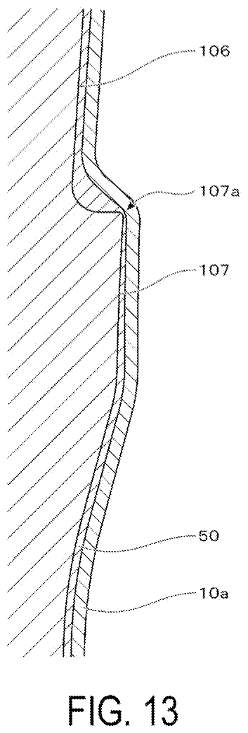

At that time, when there is a step having a certain height or more on the peripheral edge side in which the edge portion 107a of the projecting portion 107 is formed, as the preform main body 10a is stretched so as to be curved against this step, the covering material layer 50 sandwiched between the preform main body 10a and the upper surface of the projecting portion 107 is pressed, and flows so as to expand from the upper surface of the projecting portion 107 into the peripheral edge side (see FIG. 12). In this way, on the peripheral edge side in which the edge portion 107a of the projecting portion 107 is formed, the covering material layer 50 is molded thicker so that a resin pool is formed in a space between the step and the preform main body 10a, whereas the covering material layer 50 sandwiched between the preform main body 10a and the upper surface of the projecting portion 107 is molded thinner (see FIG. 13).

As a result, in the container 1 after blow molding, in the covering layer 5, the thick portion 5a in which the thickness of the covering layer 5 is thicker than the surrounding area is formed at a portion located on the edge portion 7b of the depressed portion 7 that rises from the bottom surface 7a of the depressed portion 7, and the thin portion 5b in which the thickness of the covering layer 5 is thinner than the surrounding area is formed at a portion adjacent to this thick portion 5a and located on the bottom surface 7a side of the depressed portion 7 (see FIG. 3).

When the thick portion 5a and the thin portion 5b are formed adjacent to each other in the covering layer 5 in this way, it is preferable to appropriately design the shape, dimensions, and the like of the projecting portion 107 from the perspective of more favorably breaking the thin portion 5b and separating the thick portion 5a from the thin portion 5b side, as described above.

For example, a step h₂ on the peripheral edge side in which the edge portion 107a of the projecting portion 107 is formed, that is, a height difference h₂ between the upper surface of the projecting portion 107 and the upper surface of the strip-shaped protruding portion 106 in the illustrated example, and an angle θ₂ of the edge portion 107a formed on the peripheral edge of the projecting portion 107, that is, an angle θ₂ formed between the upper surface of the projecting portion 107 and a side surface of the projecting portion 107 forming the edge portion 107a together with this upper surface, are appropriately designed from the above perspective.

Note that, as long as the thick portion 5a and the thin portion 5b can be formed adjacent to each other in the covering layer 5 as described above, the edge portion 107a formed on the peripheral edge of the projecting portion 107 may be rounded as illustrated in FIG. 10.

In addition, in the present embodiment, the projecting portion 107, on the side adjacent to the strip-shaped protruding portion 106, is provided so that the side surface forming the edge portion 107a together with the upper surface of the projecting portion 107 is concavely curved toward both end edges of the strip-shaped protruding portion 106.

Providing the projecting portion 107 in such a shape is preferable because the covering material layer 50 is pressed between the preform main body 10a and the upper surface of the projecting portion 107, and expands from the upper surface of the projecting portion 107 to the peripheral edge side so as to gather on the center side of the side surface, whereby the thick portion 5a formed in the covering layer 5 can be made thicker and more easily separated from the thin portion 5b side.

In the present embodiment, as a resin material forming the container main body 1a (preform main body 10a), ethylene terephthalate thermoplastic polyester (glass transition point: 50° C. to 90° C., melting point: 200° C. to 275° C.) such as polyethylene terephthalate can be preferably used.

As a resin material forming the covering layer 5 (covering material layer 50), it is preferable to use a thermoplastic resin that is incompatible with the resin material forming the container main body 1a from the perspective of enabling easy separation between the container main body 1a and the covering layer 5.

For example, when ethylene terephthalate thermoplastic polyester is used as the resin material forming the container main body 1a, a polyolefin resin such as polypropylene (melting point: 160° C. to 170° C.) or polyethylene (melting point: 95° C. to 140° C.) can be used as the resin material forming the covering layer 5. The polyolefin resin is commonly preferable because of having a lower melting point than the ethylene terephthalate thermoplastic polyesters, making it easier to adjust the heating temperature when heating the preform 10 to bring the covering material layer 50 into a molten state or a semi-molten state while softening the preform main body 10a to be stretchable during blow molding, but is not limited thereto.

For example, when gas barrier properties are required for the container 1, a thermoplastic resin having gas barrier properties such as ethylene-vinyl alcohol copolymer or polymethaxylylene adipamide (MXD6) can be used as the resin material forming the covering layer 5.

Further, when light-shielding properties are required for the container 1, a pigment, a colorant, or the like can be added to the resin material forming the covering layer 5 to color the container 1 in a desired hue. In order to enhance the decorative effect, a plurality of pigments and colorants can also be mixed and added to form a marble pattern. Various additives can be added to the resin material forming the covering layer 5 as necessary, without being limited by the recyclability required for the container main body 1a.

Although the present invention has been described above with reference to the preferred embodiment, the present invention is not limited only to the embodiment described above, and various modifications can be made within the scope of the present invention.

For example, the shape of the projecting portion 107 that shapes the depressed portion 7 in the container main body 1a of the container 1 is not limited to the example illustrated in the embodiment described above.

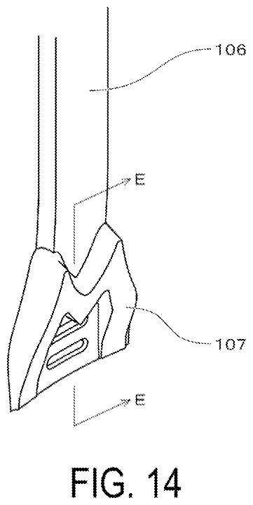

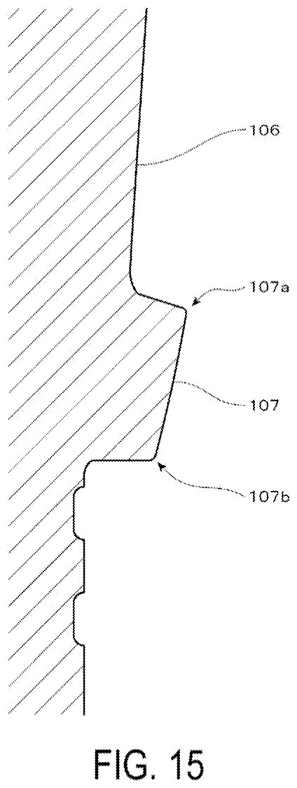

As illustrated in FIGS. 14 and 15, the projecting portion 107 may be provided in an M-shape, and a side opposite to the side adjacent to the strip-shaped protruding portion 106 may also be formed at a steep angle so that the edge portion 107b is formed on the peripheral edge. In this way, a thick portion that serves as a starting point for tearing the covering layer 5 can be formed on an edge portion of the depressed portion 7 shaped in the container main body 1a, on the opposite side of the band-shaped recessed portion 6.

Note that FIG. 14 is a perspective view of main portions of a cavity surface illustrating the modified example of the projecting portion 107 in the same manner as the example illustrated in FIG. 6, and FIG. 15 is an end view taken along line E-E of FIG. 14.

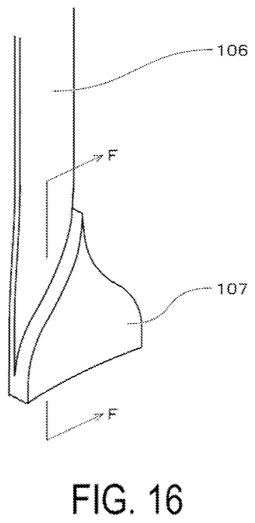

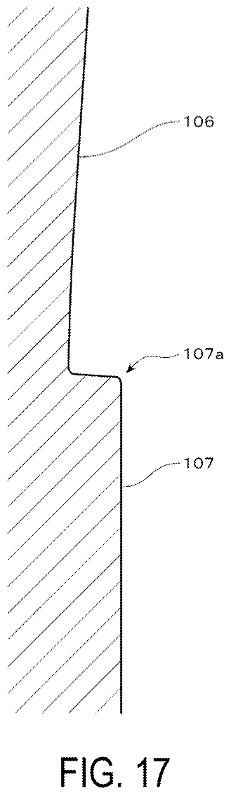

Further, the projecting portion 107 does not have to be provided so that the side surface forming the edge portion 107a together with the upper surface of the projecting portion 107 is concavely curved toward both end edges of the strip-shaped protruding portion 106 as in the embodiment described above. For example, as illustrated in FIGS. 16 and 17, a side surface may be provided so as to incline from one end side toward another end side of the strip-shaped protruding portion 106. Although not illustrated in the figure, the side surface may be provided in a plane shape orthogonal to the longitudinal direction of the strip-shaped protruding portion 106.

Note that FIG. 16 is a perspective view of main portions of a cavity surface illustrating the modified example of the projecting portion 107 in the same manner as the example illustrated in FIG. 6, and FIG. 17 is an end view taken along line F-F of FIG. 16.

Further, in the embodiment described above, the band-shaped recessed portion 6 is provided so as to extend from the upper end side to the lower end side of the body portion 3 with a predetermined width along the height direction, but is not limited thereto. The band-shaped recessed portion 6 only needs to be provided so that the linear thin portions 5c formed in the covering layer 5 along both end edges thereof function as the tear guide portion. By appropriately changing the design of the shape, dimensions, and the like of the strip-shaped protruding portion 106 that shapes the band-shaped recessed portion 6, for example, the strip-shaped protruding portion 106 may be provided in a spiral shape along the peripheral surface of the body portion 3, or may be provided so that the width of the band-shaped recessed portion 6 increases as the distance from the depressed portion 7 increases.

Further, the band-shaped recessed portion 6 provided in the container main body 1a may be omitted, and the linear thin portions 5c formed in the covering layer 5 along both end edges of the band-shaped recessed portion 6 may be omitted. In this case, intermittent break portions such as perforations along a predetermined direction may be formed in the covering layer 5 as necessary, using a CO₂ laser or the like as the tear guide portion starting from the thick portion 5a.

In short, the present invention can be modified and implemented without any limitation except for the configuration necessary to achieve this, as long as it is possible to form a starting point for tearing the covering layer 5 by providing the depressed portion 7 in the container main body 1a, forming the thick portion 5a in the covering layer 5 on the edge portion 7b of the depressed portion 7 and forming the thin portion 5b adjacent to the thick portion 5a in the covering layer 5 on the bottom surface 7a side of the depressed portion 7, breaking the thin portion 5b, and separating the thick portion 5a from the thin portion 5b side.

### REFERENCE SIGNS LIST

1 Container
1a Container main body
5 Covering layer
5a Thick portion
5b Thin portion
5c Linear thin portion (tear guide portion)
6 Band-shaped recessed portion
6a Bottom surface of band-shaped recessed portion
6b Step portion
7 Depressed portion
7a Bottom surface of depressed portion
7b Edge portion
10 Preform
10a Preform main body
50 Covering material layer
100 Blow molding die
106 Strip-shaped protruding portion
106a Edge portion
107 Projecting portion
107a Edge portion

1. A synthetic resin container comprising:
a container main body molded into a predetermined container shape; and
a covering layer laminated on an outer peripheral surface side of the container main body, wherein
the container main body has a depressed portion lower than a surrounding area, and
the covering layer has a thick portion in which a thickness of the covering layer is thicker than the surrounding area at a portion located on an edge portion of the depressed portion that rises from a bottom surface of the depressed portion, and a thin portion in which a thickness of the covering layer is thinner than the surrounding area at a portion adjacent to the thick portion and located on a bottom side of the depressed portion.

2. The synthetic resin container according to claim 1, wherein the covering layer has a tear guide portion starting from the thick portion.

3. The synthetic resin container according to claim 2, wherein
the container main body has a band-shaped recessed portion that is recessed toward the inside of the container and extends in a band shape, and the depressed portion adjacent to one end side of the band-shaped recessed portion, and
the covering layer has linear thin portions that are linearly thinner than the surrounding area, along step portions formed at both end edges of the band-shaped recessed portion, as the tear guide portion, and the thick portion is formed at a location located on the edge portion of the depressed portion that rises from the bottom surface of the depressed portion and is connected to a bottom surface of the band-shaped recessed portion.

4. A method for manufacturing a synthetic resin container including a container main body molded into a predetermined container shape and a covering layer laminated on an outer peripheral surface side of the container main body, the method comprising:
heating a preform including a preform main body having a bottomed cylindrical shape and a covering material layer laminated on an outer peripheral surface side of the preform main body to bring the covering material layer into a molten state or a semi-molten state while softening the preform main body to be stretchable; and
subsequently blow molding the preform in a blow molding die in which a cavity surface is provided with a projecting portion at a steep angle with an edge portion being formed on a peripheral edge, the projecting portion being configured to shape a depressed portion in the container main body lower than a surrounding area, wherein
the covering material layer sandwiched between the preform main body stretched and the projecting portion is made to flow expanding into a peripheral edge side in which the edge portion of the projecting portion is formed, and
the covering material layer is molded thicker on the peripheral edge side of the projecting portion in which the edge portion is formed, and the covering material layer sandwiched between the preform main body and an upper surface of the projecting portion is molded thinner.

5. The method for manufacturing a synthetic resin container according to claim 4, wherein
a cavity surface of the blow molding die is provided with a strip-shaped protruding portion that is adjacent to the projecting portion at one end side and that shapes a band-shaped recessed portion in the container main body at a steep angle such that edge portions form along both end edges, the band-shaped recessed portion being recessed toward an inside of the container and extending in a band shape, and
by pressing the covering material layer against the edge portions formed along the both end edges of the strip-shaped protruding portion, the covering material layer is molded to be linearly thin along the edge portions.
